(19) United States
(12) Patent Application Publication
(10) Pub. No.: US 2012/0287800 A1
(43) Pub. Date: Nov. 15, 2012

(54) Radio Network Node, a Node and Methods Therein for Enabling Enhanced Cell ID Timing Measurement for Positioning of a User Equipment

(75) Inventors: Iana Siomina, Solna (SE); Muhammad Kazmi, Bromma (SE); Tao Cui, Upplands Vasby (SE)

(73) Assignee: Telefonaktiebolaget L M Ericsson (publ), Stockholm (SE)

(21) Appl. No.: 13/496,091

(22) PCT Filed: Feb. 14, 2012
(86) PCT No.: PCT/SE2012/050149

§ 371 Date: Mar. 14, 2012

Related U.S. Application Data
(60) Provisional application No. 61/484,971, filed on May 11, 2011.

(51) Int. Cl. H04W 24/00

(52) U.S. Cl. 370/252

(57) ABSTRACT

Embodiments herein relate to a method in a radio network node (12) for enabling an enhanced cell Identity, E-CID, timing measurement for positioning of a user equipment (10) in a cell (11) served by the radio network node (12). The radio network node (12) obtains information that the user equipment (10) in the cell (11) is requested to perform an E-CID timing measurement. The radio network node (12) then configures uplink and/or downlink signals that are needed to perform the E-CID timing measurement.

### TECHNICAL FIELD

Embodiments herein relate to a radio network node, a node and methods therein. In particular, embodiments herein relate to enable an Enhanced Cell ID timing measurement for positioning of a user equipment in a cell.

### BACKGROUND

In today's radio communications networks a number of different technologies are used, such as Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. A radio communications network comprises radio network nodes such as radio base stations, also called eNodeB, providing radio coverage over at least one respective geographical area forming a cell. The cell definition may also incorporate frequency bands used for transmissions, which means that two different cells may cover the same geographical area but using different frequency bands. User equipments (UE) are served in the cells by the respective radio base station and are communicating with respective radio base station. The user equipments transmit data over an air or radio interface to the radio base stations in Uplink (UL) transmissions and the radio base stations transmit data over an air or radio interface to the user equipments in Downlink (DL) transmissions.

In 3rd Generation Partnership Project (3GPP) systems, e.g. LTE, a number of timing measurements are standardized, such as: user equipment Receiving (Rx)—Transmitting (Tx) time difference; eNodeB Rx−Tx time difference; Timing Advance (TA); Reference Signal Time Difference (RSTD); user equipment Global Navigation Satellite System (GNSS) Timing of Cell Frames for user equipment positioning; and Evolved—Universal Terrestrial Radio Access Network (E-UTRAN) GNSS Timing of Cell Frames for user equipment positioning. The timing measurements UE Rx−Tx time difference, eNodeB Rx−Tx time difference and Timing Advance (TA), are timing cell range measurements, for simplicity, also called herein timing measurements, since the timing measurements reflect the cell range. These timing measurements are similar to round trip time (RU) measurements in earlier systems. Furthermore, these timing measurements are based on both DL and UL transmissions. In particular, for UE Rx−Tx time difference, the user equipment measures the difference between the time of the received DL transmission that occurs after the user equipment UL transmission and the time of the UL transmission. For eNodeB Rx−Tx time difference, the eNodeB measures the difference between the time of the received UL transmission that occurs after the eNodeB DL transmission and the time of the DL transmission.
The UE Rx−Tx time difference is defined as T_{UE-RX}−T_{UE-TX}.
where
T_{UE-RX} is the user equipment received timing of downlink radio frame #i from the serving cell, defined by the first detected path in time.
T_{UE-TX} is the user equipment transmit timing of uplink radio frame #i. The reference point for the UE Rx−Tx time difference measurement shall be the user equipment antenna connector. This is applicable for Radio Resource Control (RRC)_CONNECTED intra-frequency.
The eNodeB Rx−Tx time difference is defined as T_{eNB-RX}−T_{eNB-TX},
where:
T_{eNB-RX} is the eNodeB received timing of uplink radio frame #i, defined by the first detected path in time. The reference point for T_{eNB-RX} shall be the Rx antenna connector and eNb is an abbreviation of eNobeB.
T_{eNB-TX} is the eNodeB transmit timing of downlink radio frame #i. The reference point for T_{eNB-TX} shall be the Tx antenna connector.
Timing advance (T_{ADV}) type 1 is defined as the time difference
T_{ADV}=(eNodeB Rx−Tx time difference)+(UE Rx−Tx time difference), where the eNodeB Rx−Tx time difference corresponds to the same user equipment that reports the UE Rx−Tx time difference.
Timing advance (T_{ADV}) type 2 is defined as the time difference
T_{ADV}=(eNodeB Rx−Tx time difference),
where the eNodeB Rx−Tx time difference corresponds to a received uplink radio frame containing Physical Random Access Channel (PRACH) from the respective user equipment

Timing measurements may be used for positioning, e.g. with Enhanced Cell Identification (E-CID), Adaptive Enhanced Cell ID (AECID), pattern matching, or hybrid positioning methods, for network planning, for Self-Organising Networks (SON), for enhanced Inter Cell Interference Coordination (eICIC) and for Heterogeneous Networks (HetNet), e.g. for optimizing the cell ranges of different cell types, and also for configuration of handover parameters, time coordinated scheduling, etc. Timing advance may also be used to control the timing adjustment of user equipment UL transmissions. The adjustment is transmitted to the user equipment in the timing advance command. In LTE, for user equipments not supporting LTE Positioning Protocol (LPP), the user equipment timing adjustment is based on TA type 2 only.

In addition, in e.g. LTE there are timing measurements which are implementation dependent and not explicitly standardized; one such timing measurement is a one-way propagation delay: This one-way propagation delay is measured by eNodeB for estimation of timing advanced to be signalled to the user equipment.

### Timing Measurement Procedures

UE Rx−Tx time difference measurements may be reported by the user equipment to eNodeB or a positioning node and may be requested by the respective nodes, but either both or none of the two reporting possibilities are possible with the current standard. eNodeB Rx−Tx time difference measurements may be reported e.g. to the positioning node and may also be requested by the positioning node. TA measurements require the knowledge of at least eNodeB Rx−Tx time difference and thus can only be performed by eNodeBs.

For positioning, non-contention based random access procedure may be used for eNodeB Rx−Tx and is described in the following manner P1 Step 0: Random Access Preamble assignment is signalled to the user equipment via dedicated signalling in DL, e.g. Packet Data Control Channel (PDCCH): eNodeB assigns to user equipment a non-contention Random Access Preamble, i.e. a Random Access Preamble not within a set indicated in broadcast signalling).
Step 1: The Random Access Preamble is signalled on Random Access Channel (RACH) in UL: Thus, the user equipment transmits the assigned non-contention Random Access Preamble.
Step 2: Random Access Response is signalled on Downlink Shared Channel (DL-SCH) for one or multiple user equipments in one DL-SCH message conveying at least: Timing Alignment information for UL; Timing Alignment information for DL data arrival; RA-preamble identifier.

When Carrier Aggregation (CA) is configured, the Random Access Preamble assignment via PDCCH of step 0, step 1 and 2 of the non-contention based random access procedure occur on the Primary Cell (PCeII).

The DL and UL signals used by the user equipment for performing the UE Rx−Tx time difference measurement are not explicitly specified. However typically the DL measurements may be performed by the user equipment, e.g., on Cell specific Common Reference Signals (CRS), and UL measurements may be performed by the user equipment, e.g., on Sounding Referece Signals (SRS) or Dedicated Reference Signals (DRS) or any other suitable signal. In all cases, however, the Reference Signals (RS) or the signals/channels have to be known to the user equipment. Common cell SRS configuration is provided in System Information Block (SIB), broadcasted in SIB2, and may be provided for the PCell and a secondary cell (SCell). Dedicated SRS configuration has to be configured for each user equipment; the configuration is done by the eNodeB.

### Positioning

The possibility of identifying geographical location, referred to herein as position, of the user equipment in the network has enabled a large variety of commercial and non-commercial services, e.g., navigation assistance, social networking, location-aware advertising, emergency calls, etc. Different services may have different positioning accuracy requirements imposed by the application. In addition, some regulatory requirements on the positioning accuracy for basic emergency services exist in some countries, i.e. Federal Communications Commission (FCC) E911 in the United States of America.

In many environments, the position can be accurately estimated by using positioning methods based on Global Positioning System (GPS). Nowadays networks have also often a possibility to assist user equipments in order to improve the terminal receiver sensitivity and GPS start-up performance e.g. Assisted-GPS positioning (A-GPS). GPS or A-GPS receivers, however, may be not necessarily available in all user equipments. Furthermore, GPS is known to often fail in indoor environments and urban canyons. A complementary terrestrial positioning method, called Observed Time Difference of Arrival (OTDOA), has therefore been standardized by 3GPP. In addition to OTDOA, the LTE standard also specifies methods, procedures and signalling support for Enhanced Cell ID (E-CID) and Advanced-GNSS (A-GNSS). Uplink Time Difference of Arrival (UTDOA) is also being standardized for LTE.

### Positioning Architecture in LTE

In LTE positioning architecture, the three key network elements are the Location Services (LCS) Client, the LCS target and the LCS Server. The LCS Server is a physical or logical entity managing positioning for a LCS target device by collecting measurements and other location information, assisting the user equipment in measurements when necessary, and estimating the LCS target location. A LCS Client is a software and/or hardware entity that interacts with a LCS Server for the purpose of obtaining location information for one or more LCS targets, i.e. the entities being positioned. LCS Clients may reside in the LCS targets themselves. An LCS Client sends a request to LCS Server to obtain location information, and LCS Server processes and serves the received requests and sends the positioning result and optionally a velocity estimate to the LCS Client. A positioning request can be originated from the user equipment or the network node.

Position calculation may be conducted, for example, by a positioning server, e.g. Evolved Serving Mobile Location Centre (E-SMLC) or a Secure User Plane Location (SUPL) location platform (SLP) in LTE, or a user equipment. The former approach corresponds to the user equipment-assisted positioning mode, whilst the latter corresponds to the user equipment-based positioning mode.

Two positioning protocols operating via the radio network exist in 3GPP LTE, LPP and LPP annex (LPPa). The LPP is a point-to-point protocol between a LCS Server and a LCS target device, used in order to position the LCS target device. LPP may be used both in the user plane, i.e. carrying user data traffic, and control plane, i.e. carrying control information, and multiple LPP procedures are allowed in series and/or in parallel thereby reducing latency. LPPa is a protocol between eNodeB and LCS Server specified only for control-plane positioning procedures, although it still can assist user-plane positioning by querying eNodeBs for information and eNodeB measurements. SUPL protocol is used as a transport for LPP in the user plane. LPP has also a possibility to convey LPP extension messages inside LPP messages, e.g., currently Open Mobile Alliance (OMA) LPP extensions (LPPe) are being specified to allow, e.g., for operator- or manufacturer-specific assistance data or assistance data that cannot be provided with LPP or to support other position reporting formats or new positioning methods. LPPe may also be embedded into messages of other positioning protocol, which is not necessarily LPP.

Positioning Methods and Timing Measurements that May be Used for Positioning

To meet Location Based Services (LBS) demands, the LTE network will deploy a range of complementing methods characterized by different performance in different environments. Depending on where the timing measurements are conducted and the final position is calculated, the methods may be user equipment-based, user equipment-assisted or network-based, each with own advantages. The following methods are available in the LTE standard for both the control plane and the user plane: Cell ID (CID); user equipment-assisted and network-based E-CID, including network-based Angle of Arrival (AoA); user equipment-based and user equipment-assisted A-GNSS, including A-GPS); and user equipment-assisted Observed Time Difference of Arrival (OTDOA).

Hybrid positioning, fingerprinting positioning/pattern matching and Adaptive E-CID (AECID) do not require additional standardization and are therefore also possible with LTE. Furthermore, there may also be user equipment-based versions of the methods above, e.g. user equipment-based GNSS, e.g. using GPS, or user equipment-based OTDOA, etc. There may also be some alternative positioning methods such as proximity based location. UTDOA may also be standardized in a later LTE release. Similar methods, which may have different names, also exist in other Radio Access Technologies (RAT), e.g. Code division multiple access (CDMA), WCDMA or GSM.

E-CID positioning exploit the advantage of low-complexity and fast positioning with CID which exploits the network knowledge of geographical areas associated with cell IDs, but enhances positioning further with more timing measurement types. With E-CID, the following sources of position information are involved: Cell Identification (CID) and the corresponding geographical description of the serving cell, timing measurement of the serving cell, CIDs and the corresponding signal measurements of the cells, AoA measurements. The following E-CID timing measurements from the user equipment may be reported for E-CID via LPP to the positioning node in LTE: Reference Signal Received Power (RSRP) and corresponding CIDs, e.g. up to 32 cells in LTE, including the serving cell; Reference Signal Received Quality (RSRQ) and corresponding CIDs, e.g. up to 32 cells in LTE, including the serving cell; and UE Rx−Tx time difference for the serving cell. Any of these three user equipment timing measurement types may be requested by the positioning node from the user equipment via LPP. Together with the result for the timing measurements in the cell, the user equipment also reports the cell Physical Cell Identity (PCI) and carrier frequency and may also report Cell Global Identity (CGI) and Sub Frame Number (SFN).

The user equipment may also report timing measurements for E-CID over Radio Resource Control (RRC) to the eNodeB, which may then be reported by eNodeB to the positioning node. E.g. RSRP and corresponding CIDs, RSRQ and corresponding CIDs, ans UE Rx−Tx time difference for the serving cell.

In addition to the timing measurements above, the user equipment may also report the SFN of the cell wherein the user equipment performed the timing measurements and other measurements e.g. inter-RAT measurements, or information e.g. Closed Subscriber Group (CSG) indicator indicating whether the user equipment is a member of the CSG of the measured cell. The E-UTRAN timing measurements available for E-CID transmitted from eNodeB via LPPa to the positioning node are: RSRP and RSRQ and corresponding CIDs, up to 32 cells in LTE, including the serving cell; Timing Advance (TA) Type 1 i.e. eNodeB Rx−Tx time difference+UE Rx−Tx time difference for the serving cell; TA Type 2 i.e. eNodeB Rx−Tx time difference for the serving cell; and UL AoA for the serving cell. Any of the four timing measurement types above can be requested by the positioning node from eNodeB via LPPa. As stated, UE Rx−Tx time difference and TA Type 2 are defined only for the serving cell and thus also TA Type 1 is also defined only for the serving cell, or PCeII in a CA network.

The timing measurements for E-CID are not restricted to be performed on any specific channel or signal, neither for DL nor for UL. The DL Rx measurements, however, are more likely to be performed on CRS signals. For the UL Tx, the user equipment may use any of UL transmissions, e.g., the definition of TA Type 2 suggests that PRACH transmissions may be used. The accuracy tests for UE Rx−Tx time difference measurements are specified assuming configured SRS transmissions, but SRS transmissions are expected to give better performance at least because they are transmitted periodically and may be more dense. Timing measurements standardized for E-CID may also be used for other positioning measurement, e.g., AECID, Radio Frequency (RF) pattern matching or fingerprinting and hybrid positioning.

### UE Rx−Tx Timing Measurements for Non-Serving Cells or Secondary Cells (SCells)

That the user equipment may report intra-frequency and inter-frequency UE Rx−Tx timing measurements, i.e., the measurements being performed in at least one cell which is not a serving cell and not a PCell, has been disclosed as well as reporting criteria in the user equipment for these timing measurements.

However, the prior art solutions provide an insufficient signaling support even for the standardized single-cell UE Rx−Tx timing measurements triggered by the positioning node in LTE, e.g. the user equipment may fail to perform the requested timing measurements due to that the signals are not configured by eNodeB which is not aware of that the user equipment was requested to perform the measurements, and it may not be possible to meet the requirements without ensuring that the necessary radio signals that have to be measured are configured. A similar problem may occur with other timing measurements, e.g. timing measurements that involve at least transmissions in UL, e.g., TA, user equipment RTT, propagation delay or similar.

E-CID timing measurements, such as UE Rx−Tx time difference measurements, in the current specification has to rely on the configured UL transmissions and the configured DL transmissions, which may lead to poor measurement quality or even measurement failure in the worst case, e.g., when the DL or UL signals are not available or available sparsely in time or over a small bandwidth, for example, when SRS are not configured or CRS are not transmitted due to power saving or emergency. Further, since eNodeB is not aware of the UE Rx−Tx time difference measurement requested by the positioning node from the user equipment, there is no means in a general case to ensure that the DL transmission occurs after receiving the user equipment UL transmission. The problem becomes even more severe if UE Rx−Tx time difference measurement is to be performed on at least one inter-frequency, since the user equipment may need measurement gaps and the user equipment may not have any precise cell timing knowledge, e.g. in an asynchronous network, which may be not available for SCell either.

### SUMMARY

An object of embodiments herein is to enable reliable positioning of a user equipment in an efficient manner.

According to an aspect of embodiments herein the object is achieved by a method in a radio network node for enabling an E-CID timing measurement for positioning of a user equipment in a cell served by the radio network node. The radio network node obtains information that the user equipment in the cell is requested to perform an E-CID timing measurement by a positioning node. The radio network node then configures uplink and/or downlink signals that are needed to perform the E-CID timing measurement.

According to another aspect of embodiments herein the object is achieved by method in a node for enabling an E-CID timing measurement for positioning of a user equipment in a cell served by a radio network node. The node provides information to a radio network node, which information indicates that the user equipment in the cell is requested by the positioning node to perform an E-CID timing measurement.

According to still another aspect of embodiments herein the object is achieved by a radio network node for enabling the E-CID timing measurement for positioning of the user equipment in the cell. The radio network node is configured to serve the cell. The radio network node comprises an obtaining circuit configured to obtain information that the user equipment in the cell is requested to perform an E-CID timing measurement by the positioning node. Furthermore the radio network node comprises a configuring circuit arranged to configure uplink and/or downlink signals that are needed to perform the E-CID timing measurement.

According to still another aspect of embodiments herein the object is achieved by a node for enabling an E-CID timing measurement for positioning of the user equipment in the cell served by the radio network node. The node comprises a providing circuit configured to provide information to the radio network node, which information indicates that the user equipment in the cell is requested by the positioning node to perform an E-CID timing measurement.

Since the radio network node is informed about the request by the node, e.g. the positioning node, the configuration is set up and a reliable E-CID timing measurement may be performed and hence a reliable position of the user equipment may be calculated.

### BRIEF DESCRIPTION OF THE DRAWINGS

Embodiments will now be described in more detail in relation to the enclosed drawings, in which:

FIG. 1 is a schematic overview of a radio communications network according to embodiments herein,

FIG. 2 is a combined flowchart and signalling scheme according to embodiments herein,

FIG. 3 is a combined flowchart and signalling scheme according to embodiments herein,

FIG. 4 is a schematic flowchart depicting a method in a radio network node according to embodiments herein,

FIG. 5 is a schematic flowchart depicting a method in a node according to embodiments herein,

FIG. 6 is a schematic overview depicting a definition of a SRS configuration,

FIG. 7 is a block diagram depicting a radio network node according to embodiments herein,

FIG. 8 is a block diagram depicting a node according to embodiments herein, and

FIG. 9 is a block diagram depicting a radio communications network.

### DETAILED DESCRIPTION

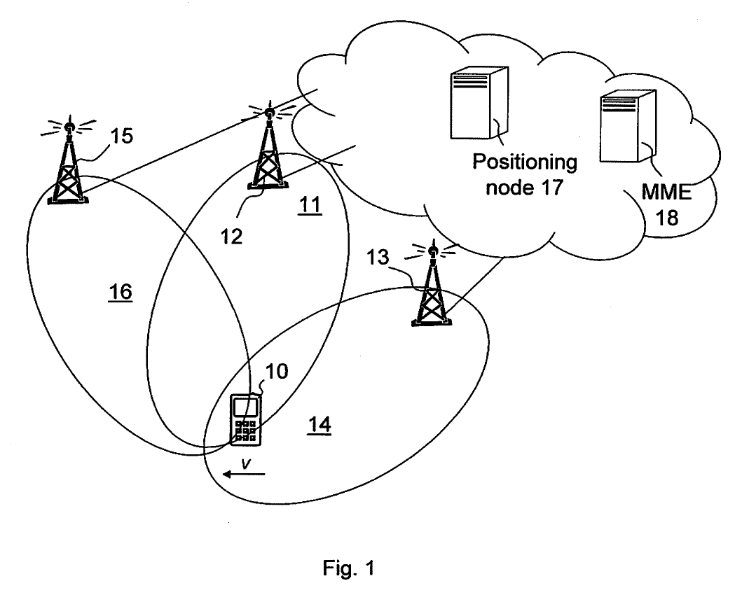

FIG. 1 is a schematic overview of a radio communications network such as a LTE, LTE-Advanced, WCDMA, GSM/EDGE, WiMax or UMB network just to mention a few possible implementations. A user equipment 10 is served in the radio communications network. The radio communications network comprises a radio network node 12, such as a first radio base station, providing radio coverage over at least one geographical area forming a first cell 11, also referred to herein as the cell 11. Furthermore, the radio communications network comprises another radio network node 13. The other radio network node 13 provides radio coverage over a second geographical area forming a second cell 14. The user equipment 10 is served in the second cell 14 by the other radio network node 13 and is communicating with the other radio network node 13. The user equipment 10 transmits data over a radio interface to the other radio network node 13 in an uplink (UL) transmission and the other radio network node 13 transmits data to the user equipment 10 in a downlink (DL) transmission. The radio communications network may further comprise a third radio network node 15. The third radio network node 15 provides radio coverage over a third geographical area forming a third cell 16. Furthermore, the radio communications network may comprise a positioning node 17 and a Mobility Management Entity (MME) 18 arranged in a core network of the radio communications network.

The positioning node 17 may also be exemplified as a Location Service (LCS) server, Server Mobile Location Centre (SMLC), Secure User Plane Location (SUPL) Location Platform (SLP) or any server enabled to perform positioning of the user equipment 10.

It should be understood that the term “user equipment” is a non-limiting term which means any wireless terminal, device or node e.g. Personal Digital Assistant (PDA), laptop, mobile, mobile tablet, sensor, relay, or even a small base station that are being positioned, e.g. an LCS target in general. The user equipment 10 may also be capable and not capable of performing inter-frequency measurements without gaps, e.g. a user equipment capable of carrier aggregation.

The respective radio network node 12, 13, 15, which are exemplified in FIG. 1 as radio base stations may further be exemplified as a relay nodes or a beacon nodes. A radio base station may also be referred to as e.g. a NodeB, an evolved Node B (eNB, eNode B), a base transceiver station, Access Point Base Station, base station router, or any other network unit capable to communicate with the user equipment 10 within the cells 11, 14, 16 depending e.g. of the radio access technology and terminology used. Also, the respective radio network node 12, 13, 15 may further serve one or more cells.

The user equipment 10 moves towards the radio network node 12 with a velocity v and a handover is performed to the first cell 11 served by the radio network node 12. Thus, the user equipment 10 is then served by the radio network node 12.

Embodiments herein enable E-CID timing measurement for positioning, e.g. UE Rx−Tx time difference, requested from the user equipment 10 by the positioning node 17. For example, the positioning node 17 may request E-CID timing measurements from the user equipment 10 via LPP. Such measurements may be: RSRP and corresponding CIDs, e.g. up to 32 cells in LTE, including the serving cell; RSRQ and corresponding CIDs, e.g. up to 32 cells in LTE, including the serving cell; and UE Rx−Tx time difference for the serving cell. The positioning node 17 may send an indication to the radio network node 12 that E-CID timing measurements are requested from the user equipment 10. Thus, the radio network node 12 obtains information that the user equipment 10 in the first cell 11 is requested to perform an E-CID timing measurement by the positioning node 17. Embodiments herein disclose different ways to obtain the information from different nodes within the radio communications network. The radio network node 12 then configures uplink and/or downlink signals that are needed to perform the E-CID timing measurement. Thereby, the E-CID timing measurements are reliable and thus the positioning of the user equipment 10 is also reliable.

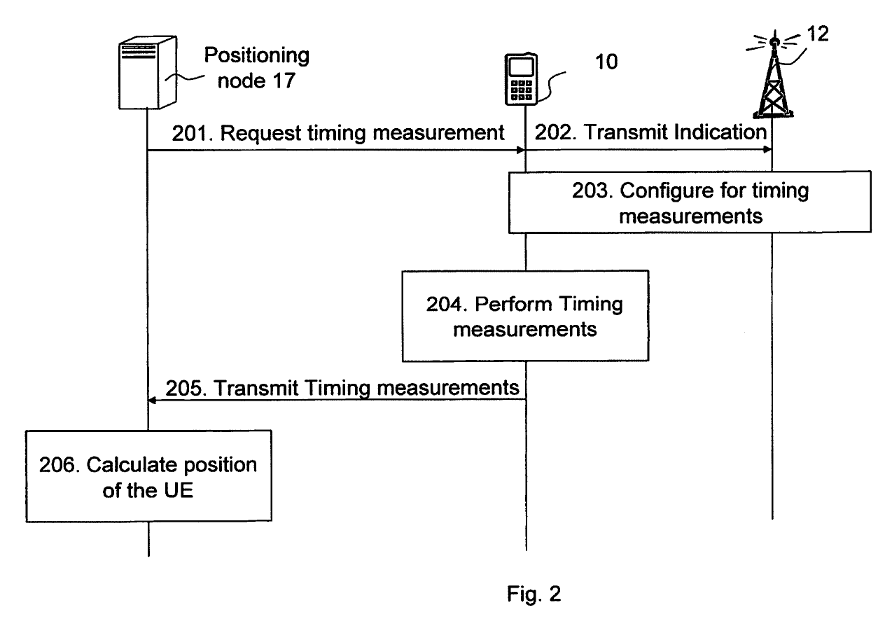

FIG. 2 is a schematic combined flowchart and signalling scheme according to some examples of embodiments herein.

Action 201. The positioning node 17 requests E-CID timing measurements for positioning from the user equipment 10. Such E-CID timing measurements may be UE Rx−Tx time difference or similar. This request is communicated via (not shown) a radio network node, such as the radio network node 12.

Action 202. In this example, the user equipment 10 informs the radio network node 12 that E-CID timing measurements are requested from the user equipment 10. Thus, the radio network node obtains the information that the E-CID timing measurement is requested from the user equipment 10.

Action 203. The radio network node 12 then configures the DL and/or UL signals for being used to perform the E-CID timing measurements.

Action 204. The user equipment 10 then performs the E-CID timing measurements.

Action 205. The user equipment transmits the E-CID timing measurements to the positioning node 17 requesting the E-CID timing measurements.

Action 206. The positioning node 17 may then calculate the position of the user equipment 10 using the E-CID timing measurements.

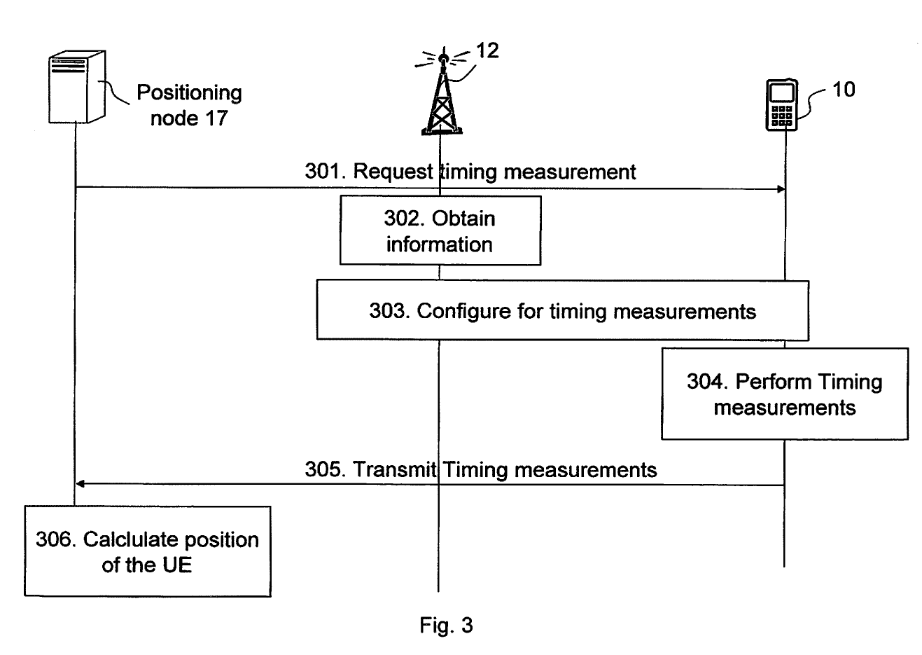

FIG. 3 is a schematic combined flowchart and signalling scheme according to some other examples of embodiments herein.

Action 301. The positioning node 17 requests E-CID timing measurements for positioning from the user equipment 10.

Action 302. In this example, the radio network node 12 packet sniffs, also referred to as cross layer communicates, the packets in the request for E-CID timing measurements and thereby the radio network node 12 obtains information, from the positioning node 17, that E-CID timing measurements are requested from the user equipment 10.

Action 303. The radio network node 12 then configures the DL and/or UL signals for being used to perform the E-CID timing measurements.

Action 304. The user equipment 10 performs the E-CID timing measurements.

Action 305. The user equipment 10 then transmits the E-CID timing measurements to the positioning node 17 requesting the E-CID timing measurements.

Action 306. The positioning node 17 may then calculate the position of the user equipment 10 using the E-CID timing measurements.

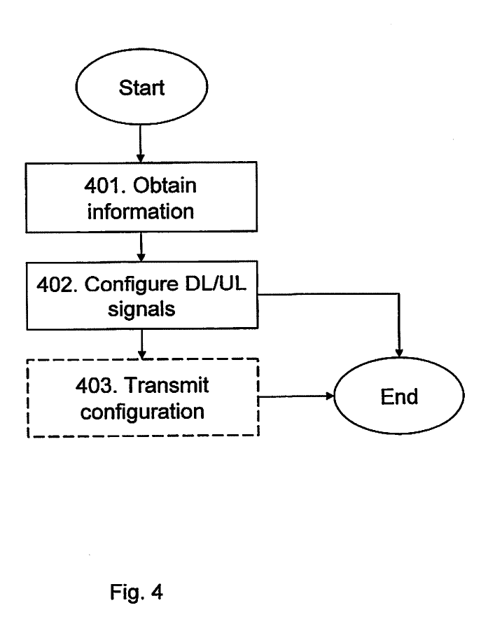

FIG. 4 is a schematic flowchart depicting embodiments herein of a method in the radio network node 12 for enabling an E-CID timing measurement for positioning of the user equipment 10 in the cell, exemplified as the first cell 11, served by the radio network node 12. The radio network node may be any of: eNode B, relay, donor eNode B, base station, Multi-Standard Radio (MSR) node, beacon device, access point or a repeater.

Action 401. The radio network node obtains information that the user equipment 10 in the first cell 11 is requested to perform an E-CID timing measurement by the positioning node 17. The information may be received from a first node e.g. the user equipment 10, the positioning node 17, another radio network node 13, a core network node e.g. MME 18, or a gateway node. In some embodiments the information further comprises a configuration of at least the downlink or uplink signal.

Thus, the first node 10, 13, 17, 18 indicates to a second node that the E-CID measurement, e.g. UE Rx−Tx time difference measurement, is being requested by a third node, from the user equipment 10. The second node is the radio network node 12 e.g. Location Measurement Unit (LMU) or eNodeB that may or may not be the serving node. The third node may be the positioning node 17 or the MME 18,

The information may indicate that the request has been sent to the user equipment 10, e.g. the information being the E-CID timing measurement or configuration, or may actually be the request itself. An indication may thus be sent to the radio network node 12 by the positioning node 17, which may send the indication via LPPa or similar protocol to the radio network node 12. The positioning node 17 may also send the request for the E-CID timing measurement to the user equipment 10. Hence in this case first and third nodes are the same. Alternatively or additionally the indication may thus be sent to the radio network node 12 by the user equipment 10 which is requested to perform the E-CID timing measurements. The user equipment 10 may send the indication to the radio network node 12 via RRC. In some embodiments, the indication may be defined similarly to a new indication message for positioning or E-CID specifically may be used. The indication may even be included in a measurement gap indication message for OTDOA sent over RRC from the user equipment 10 to the radio network node 12. Thus, the information may be obtained in a measurement gap indication message or a measurement gap request message. The indication may in some embodiments be sent to the radio network node 12 by a serving radio network node 13, e.g. before handed over to the radio network node 12 the indication may be sent by the other radio network node 13 to the radio network node 12 involved in the E-CID timing measurement via X2 or the indication may be sent to a target cell 11 via X2 during the handover. Furthermore, the indication may be sent from the core network node, e.g. MME 18 in LTE, to the radio network node 12 via S1 interface. It should also be noted that the indication may be sent from the gateway node in the core network, e.g. femto gateway node.

The indication may comprise additional information such as any of the information described in Enhanced configuration information. The additional information may be:

measurement bandwidth of the UE Rx−Tx time difference measurement on each carrier over which the measurement is to be performed;

cell or node identification for DL and/or UL;

frequency/Carrier Component (CC) for DL and/or UL;

indication for measurement gaps and the information indicating the necessary or preferred measurement gap configuration;

signals type and signal configuration for the E-CID timing measurement for DL and/or UL;

UE Rx−Tx time difference measurement periodicity e.g. aperiodic or periodic with a certain period;

duration or time (T0) over which the configuration should be done by the radio network node 12 or similar.

In some embodiments, only aperiodic UE Rx−Tx time difference measurements may be requested over LPP. In some embodiments, the radio network node 12 obtains the information via a cross layer communication by reading a positioning measurement request message sent to the user equipment 10 via the radio network node 12. Thus, the radio network node 12 may read a higher layer packets (e.g. LPP) by cross layer communication to determine if the UE Rx−Tx time difference measurements have been configured by the positioning node 17. The radio network node 12 may then configure the necessary DL and/or UL signals if this UE Rx−Tx time difference measurement has been requested. Furthermore, the radio network node 12 may even configure appropriate measurement Band Width (BW) as read in LPP via cross layer communication. In one example, the cross-layer communication may be implemented via packet sniffing.

The obtained information comprises one or more indication of: type of uplink signal and/or downlink signal for performing the E-CID timing measurement; bandwidth of uplink signal and/or downlink signal; frequency or component carrier; cell or node identification associated with said uplink and/or downlink signal; time period over which the E-CID timing measurement is done; periodicity of the E-CID timing measurement; Sounding Reference Signal (SRS) information; and/or measurement gap indication message.

According to embodiments herein the positioning node 17, e.g. E-SMLC, may request the radio network node 12. e.g. an eNode B, performing eNodeB Rx−Tx time difference measurement to use one or more specified configuration. The specified configuration may be a measurement bandwidth over which the eNodeB Rx−Tx time difference measurement is to be performed for each carrier e.g. measurement bandwidth of 50 Resource Blocks (RBs) to be used for a first carrier f1 and 25 RB for a second carrier f2. Additionally or alternatively, the specified configuration may be UL signals transmitted by the user equipment 10 are to be used for performing the eNodeB Rx−Tx time difference measurement on each carrier e.g. use of SRS for the first carrier f1 in LTE.

In some embodiments, the obtained information is comprised in positioning measurement request message sent by positioning node 17 to the user equipment 10. According to some embodiments, if the positioning node 17 is not aware of whether the user equipment 10 will be able to perform the UE Rx−Tx time difference upon its request, e.g. not aware that the necessary signals are configured, that measurement gaps are configured if necessary or that they are not necessary, the request for UE Rx−Tx time difference is transmitted to the radio network node 12. Otherwise, e.g. when positioning node 17 is aware of the necessary signal configurations, e.g. that the default system configuration is sufficient, or at least about that the user equipment 10 has been using it recently, e.g., using SRS for UTDOA, the radio network node 12 transmits the UE Rx−Tx time difference request to the user equipment 10.

Action 402. The radio network node 12 configures uplink and/or downlink signals that are needed to perform the E-CID timing measurement.

Upon receiving the indication the radio network node 12 may execute at least one of:

configuring the necessary DL signals or DL message, and sending a message to the user equipment 10;

configuring the necessary UL signals, e.g. SRS, and the configuration may also be communicated to the user equipment 10 in a message, e.g. via a broadcast such as via a system information or unicast signaling such as that over RRC;

configuring measurement gaps if necessary, responding to the user equipment message or signal, e.g. configured by the radio network node 12, if necessary or indicating to the other radio network node 13 that the other radio network node 13 will be involved in the UE Rx−Tx time difference measurement;

configuring the DL and/or UL signals over the measurement bandwidth for each carrier as requested by the first node 10, 13, 17, 18.

The above configuration may be done over a time period in accordance with a pre-defined measurement period over which the UE Rx−Tx time difference measurement and accuracy requirements are defined. Alternatively the above configuration can also be done over a time period T0, where the time period T0 is explicitly indicated by the first node, e.g. the user equipment 10; the positioning node 17; the other radio network node 13, the core network node or the gateway node

After performing one or more of the above tasks, the radio network node 12 may also send a confirmation message to the first node e.g. the user equipment 10. The first node 10, 13, 17, 18 then sends an indication or request that UE Rx−Tx time difference measurement has been done. The message may also comprise tasks performed. The radio network node 12 may also send a failure message to the first node 10, 13, 17, 18 in case the request cannot be furnished.

In some embodiments, the radio network node 12 configures the uplink and/or downlink signals based on obtained configuration information. The configuration information may be communicated e.g. when requesting performing timing measurements. The UE Rx−Tx time difference measurements may be requested e.g. by a network node, such as the positioning node 17, from the user equipment 10, by a network node, such as the e.g. positioning node 17 from the radio network node 12, or by the radio network node 12, e.g. serving cell eNodeB, from the user equipment 10. Furthermore, the configuration information may be communicated by acquiring, e.g., by user equipment 10 or the radio network node 12, the configuration information for performing the E-CID timing measurements. Additionally or alternatively, the configuration information may be communicated by requesting, e.g., by the radio network node 12 or the positioning node 17, configuring or acquiring, e.g., by the user equipment 10 or the radio network node 12 the configuration information for configuring transmissions, signals or channels, necessary for performing the E-CID timing measurements. The configuration information may be communicated when reporting, e.g., by the user equipment 10 or the radio network node 12, the E-CID timing measurements. The configuration information may also be communicated to enable or optimize configuration of the E-CID timing measurements in the radio network node 12 configuring the E-CID timing measurements. For example, the positioning node 17 gets the information from SON, Operation, Administration and Maintenance and Management (O&M) node or radio network node 12; radio network node 12 gets the information from positioning node 17, SON or O&M node; user equipment 10 gets the information from a network node 18 or the radio network node 12.

In some embodiments the radio network node 12 performs configuration of: downlink signal over a bandwidth in one or more cells operating on one or more frequencies; uplink signal over a bandwidth in one or more cells operating on one or more frequencies; measurement gap; and/or time period over which said downlink signal and/or uplink signal are transmitted. The radio network node may configure the DL and/or UL signals based on obtained configuration information, alternatively or additionally, based on pre-defined configuration information. According to some embodiment, the necessary configuration is pre-defined or pre-configured in the radio network node 12. According to some other embodiments, the configuration is determined as the necessary or sufficient based on the information about the system configuration or propagation environment, difficult or nearly Line Of Sight (LOS), indoor or outdoor, etc. For example, SRS for UL measurements may be not always necessary, e.g. configuring SRS may be avoided for intra-frequency UE Rx−Tx time difference measurements on PCell when e.g. contention-based random access procedure may also be used for the UE Rx−Tx time difference measurement. Similarly the pre-defined measurement bandwidth may be expressed as the BW of the cell. Similarly in some other examples the pre-defined measurement bandwidth may be defined to be equal to the BW of the Pcell or even the BW equal to the minimum of the Pcell BW and Scell BW etc.

The enhanced configuration information similar to what has been described for UE Rx−Tx time difference may be provided to facilitate eNodeB Rx−Tx time difference, for which the radio network node 12 transmits signals and then performs measurements on the corresponding UL transmissions from the user equipment 10. Since both user equipment 10 and the radio network node 12 are involved in eNodeB Rx−Tx time difference, as in UE Rx−Tx time difference, the information may be communicated for eNodeB Rx−Tx time difference in a similar way, e.g., similar nodes may be involved in the communication as for UE Rx−Tx time difference and similar information may be communicated.

In LTE, TA involves Rx−Tx time difference requirements, which means that the enhanced information as described for UE Rx−Tx time difference and eNode Rx−Tx time difference may also be used for TA and the described ways of obtaining information may also be applied for TA or other similar measurements.

In some embodiments the radio network node 12 may configure the DL and/or UL signals over a time period. The time period may be predefined or indicated from the user equipment 10; the positioning node 17; another radio network node 13, or the core network node 18. The uplink signal may be at least one of a Sounding Reference Signal (SRS) and a Dedicated Reference Signal (DRS). The downlink signal may be at least one of a Cell Specific Reference Signal (CRS) and a Demodulation Reference Signal (DMRS).

Action 403. The radio network node 12 may, according to some embodiments as indicated by the dashed box, transmit the configuration of downlink signal and/or the uplink signal to the user equipment 10, the positioning node 17 or the other radio network node 13.

In previous systems no information has been provided when requesting or configuring any of the E-CID timing measurements. This is because the only possible configuration has been for the serving cell 14 or PCell, using the same cell in DL and UL, over the frequencies determined by the System Information, SI, which does not require any signalling to describe the configuration for the E-CID timing measurement since the serving cell or PCell was known. However, to enable the flexibility of the E-CID timing measurement provided by the embodiments herein, e.g. to allow performing the E-CID timing measurements across different frequencies or with different Tx and Rx points, either more information needs to be communicated between the different nodes to configure/request/report the E-CID timing measurements or some rules based on which the configuration of the E-CID timing measurement may be determined are necessary. The enhanced configuration is described by the examples given below for UE Rx−Tx time difference, eNodeB Rx−Tx time difference, and TA measurements.

At least one of the following may be used to describe or enable the configuration of the UE Rx−Tx time difference measurements, i.e. the user equipment transmits in UL and then performs measurements on the corresponding DL transmissions:

Cell IDs or node IDs, currently, E-CID timing measurements are defined only for the serving cell 11 and the UL and DL transmissions are associated with the same cell identification and thus no reason to include this information. At least some embodiments may benefit from providing both the DL and UL cell information since the embodiments do not require the DL and UL configurations to be the same as those predefined or determined by the system for general purpose, e.g., there is no need to assume that DL and UL transmissions are associated with the same cell identifications or node identifications;

Cell type or the indicator related to it, if different provided for both DL and UL, e.g. primary, secondary, configured/non-configured or activated/deactivated secondary cell or CC, macro, CSG femto, non-CSG femto, pico, synchronized or non-synchronized, cell using normal cyclic prefix or cell using extended cyclic prefix;

Frequency information, e.g., carrier frequency/CC/frequency band), wherein at least some embodiments may benefit from providing both the DL and UL frequency information since the embodiments do not require the DL and UL frequencies to be the same as those predefined or determined by the system for general purpose;

RAT, e.g. if RAT being different from the serving RAT, it may be provided for any of DL and UL transmissions involved in the E-CID timing measurements;

already configured or necessary to configure measurement gap configuration or an indication describing a possible/preferable measurement gap configuration, e.g., the indication may be an offset and/or periodicity and/or pattern describing a measurement gap configuration. E.g. depending on user equipment measurement capability and a CC configuration, the user equipment 10 may or may not require measurement gaps for performing the E-CID timing measurements;

Type of signals/channels and/or their configuration for performing the E-CID timing measurements, e.g. for UL transmissions, where the type of signals/channels may comprise at least one of: SRS common, SRS dedicated, DRS, any other physical signal or channel transmitted in UL. Configuration may comprise at least one of: UL transmission bandwidth; UL measurement bandwidth; transmission or measurement periodicity; number of antenna ports; power or power offset; measurement or transmission patterns if any. For DL transmissions, where the type of signals/channels may comprise at least one of: CRS, Demodulation Reference Signal (DM RS), synchronization signals, any other physical signal or channel transmitted in DL. The configuration may comprise at least one of: DL transmission bandwidth, DL measurement bandwidth, transmission or measurement periodicity, number of antenna ports, power or power offset, measurement or transmission patterns if any or similarly.

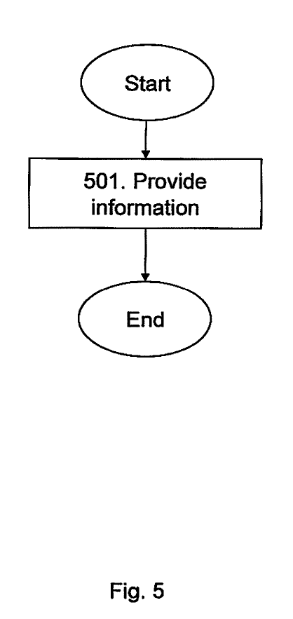

FIG. 5 is a schematic flowchart depicting embodiments herein of a method in a node for enabling an E-CID timing measurement for positioning of the user equipment 10 in a cell 11 served by the radio network node 12. The node may the user equipment 10, the other radio network node 13, the positioning node 17 or the MME 18.

Action 501. The node provides information to the radio network node 12. The information indicates that the user equipment 10 in the cell 11 is requested by the positioning node 17 to perform an E-CID timing measurement. The provided information may be comprised in a measurement gap indication message or a measurement gap request message. The provided information may comprise one or more indications of: type of uplink signal and/or downlink signal for performing the E-CID timing measurement; bandwidth of uplink signal and/or downlink signal; frequency or component carrier; cell or node identification associated with said uplink and/or downlink signal; time period over which the E-CID timing measurement is done; periodicity of the E-CID timing measurement; Sounding Reference Signal information; and/or measurement gap indication message. This is the case where positioning node 17 directly sends a message to the radio network node 12 e.g. over LPPa interface between the radio network node 12 and the positioning node 17.

In some embodiments, wherein the node is the positioning node 17, the provided information is comprised in a positioning measurement request message. The node then provides the information by sending the positioning measurement request message to the user equipment 10 via the radio network node 12. This is the case of cross layer communication indicated above i.e. the radio network node 12 reads LPP message sent by the positioning node 17 to the user equipment 10.

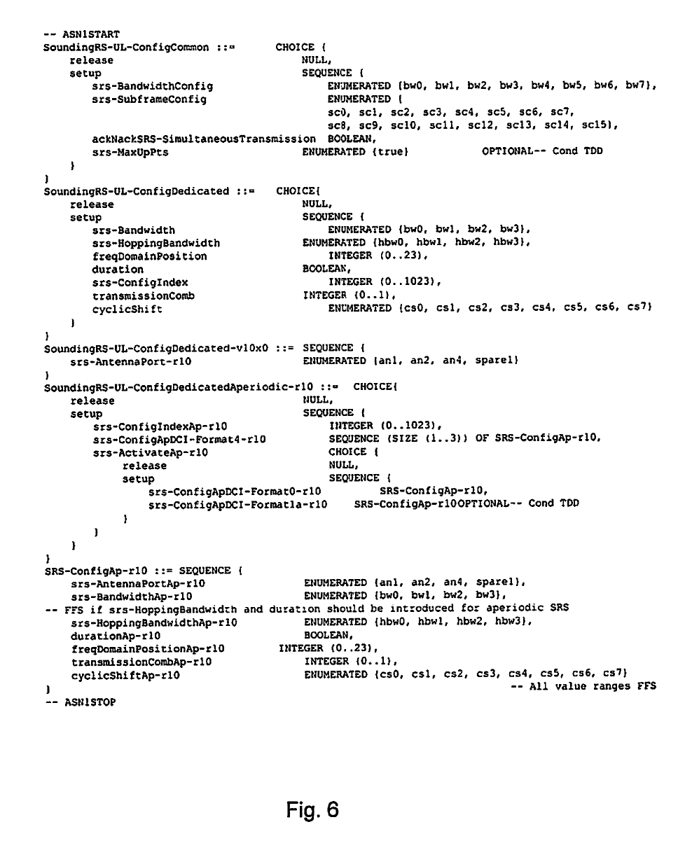

FIG. 6 is an example of an information element (IE) comprising typical SRS configuration parameters that are currently specified by the standard. This IE is sent by the radio network node 12 to the user equipment 10 using RRC signalling for enabling the user equipment 10 to transmit the SRS according to the configuration in the IE. The received SRS signalled at the radio network node 12 is typically used by the radio network node 12 for performing channel dependent scheduling in the uplink. The SRS can also be used for the timing measurements, which may be used for E-CID positioning. Embodiments herein, however, are neither limited to this particular set of configuration parameters nor to SRS.

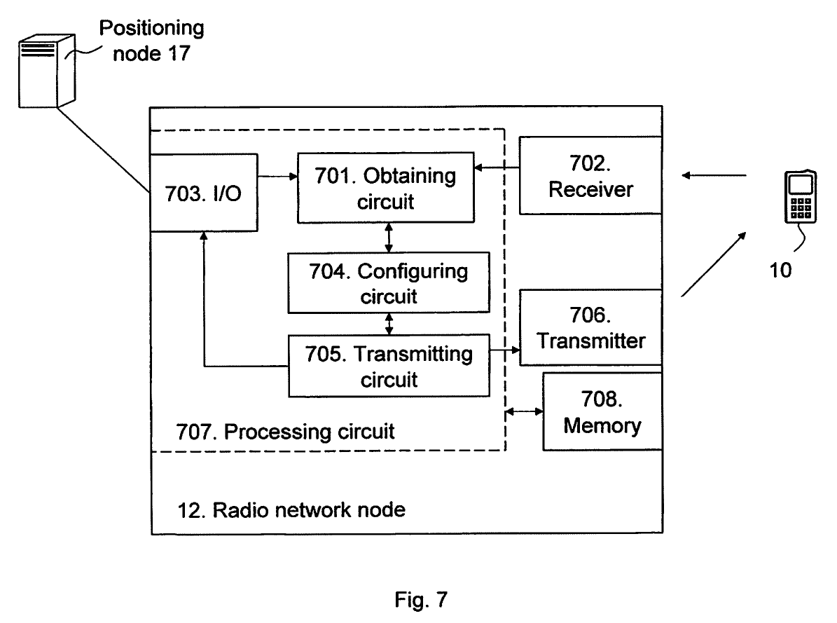

FIG. 7 is a block diagram depicting a radio network node 12 according to embodiments herein for enabling the E-CID timing measurement for positioning of the user equipment 10 in a cell 11. The radio network node 12 is configured to serve the cell 11.

The radio network node 12 comprises an obtaining circuit 701 configured to obtain information that the user equipment 10 in the cell 11 is requested to perform an E-CID timing measurement by the positioning node 17. The obtaining circuit 701 may be configured to receive the information from any of: the user equipment 10; the positioning node 17; the other radio network node 13, the core network node 18 or the gateway node. The obtained information may be comprised in a measurement gap indication message or measurement gap request message. The obtaining circuit 701 may be configured to obtain the information via cross layer communication by reading a positioning measurement request message sent to the user equipment 10 via the radio network node 12. The information may further comprise a configuration of at least the downlink or uplink signal. In some embodiments the obtained information may further comprise one or more of: type of uplink signal and/or downlink signal for performing the E-CID timing measurement; bandwidth of uplink signal and/or downlink signal; frequency or component carrier; cell or node identification associated with said uplink and/or downlink signal; time period over which the E-CID timing measurement is done; periodicity of the E-CID timing measurement; and/or measurement gap indication message. The obtained information is comprised in positioning measurement request message sent by the positioning node 17 to the user equipment 10. The information may be obtained via a receiver 702 configured to receive the information over an air interface or via an inout/output (I/O) interface 703 connected to a network. The E-CID timing measurement may be any of: UE Rx−Tx time difference; radio network node Rx−Tx time difference, timing advanced or propagation delay between the user equipment 10 and the radio network node 12.

The radio network node 12 further comprises a configuring circuit 704 arranged to configure uplink and/or downlink signals that are needed to perform the E-CID timing measurement. The configuring circuit 704 may in some embodiments be arranged to perform configuration of: downlink signal over a bandwidth in one or more cells operating on one or more frequencies; uplink signal over a bandwidth in one or more cells operating on one or more frequencies; measurement gap; and/or time period over which the said downlink signal and/or uplink signal are transmitted. The configuring circuit 704 may be arranged to perform configuration based on obtained configuration information. The configuring circuit 704 may further be arranged to perform configuration based on pre-defined configuration information. Additionally or alternatively, the configuring circuit 704 may be arranged to perform the configuration over a time period. The time period is predefined or indicated from the user equipment 10 a positioning node 17; another radio network node 13, or a core network node 18. The uplink signal may be at least one of a Sounding Reference Signal and a Dedicated Reference Signal. The downlink signal may be at least one of a Cell specific Reference Signal and a Demodulation Reference Signal.

The radio network node may comprise a transmitting circuit 705 configured to transmit the configuration of downlink signal and/or the uplink signal to the user equipment 10, the positioning node 17 or another radio network node 13. This may be performed via a transmitter 706 to the user equipment or the I/O 703.

The embodiments herein for enabling the E-CID timing measurement for positioning of the user equipment 10 may be implemented through one or more processors, such as a processing circuit 707 in the radio network node 12 depicted in FIG. 7, together with computer program code for performing the functions and/or method steps of the embodiments herein. The program code mentioned above may also be provided as a computer program product, for instance in the form of a data carrier carrying computer program code for performing embodiments herein when being loaded into the radio network node 12. One such carrier may be in the form of a CD ROM disc. It is however feasible with other data carriers such as a memory stick. The computer program code may furthermore be provided as pure program code on a server and downloaded to the radio network node 12. Those skilled in the art will also appreciate that the various “circuits” described may refer to a combination of analog and digital circuits, and/or one or more processors configured with software and/or firmware, e.g., stored in memory, that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The radio network node 12 may further comprise a memory 708. The memory 708 may comprise one or more memory units and may be used to store for example data such as E-CID timing measurements, configuration information, identities, scheduling data, application/s to perform the methods herein when being executed on the radio network node 12 and/or similar.

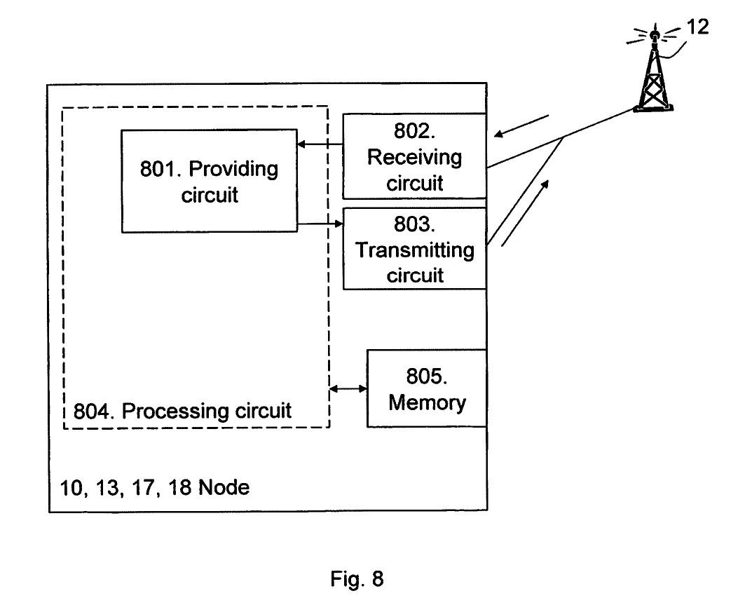

FIG. 8 is a block diagram depicting a node 10, 13, 17, 18 for enabling an E-CID timing measurement for positioning of the user equipment 10 in the cell 11 served by the radio network node 12.

The node comprises a providing circuit 801 configured to provide information to the radio network node 12. The information indicates that the user equipment 10 in the cell 11 is requested by the positioning node 17 to perform an E-CID timing measurement.

The provided information may be comprised in a measurement gap indication message or a measurement gap request message. The provided information may comprise one or more indications of: type of uplink signal and/or downlink signal for performing the E-CID timing measurement; bandwidth of uplink signal and/or downlink signal; frequency or component carrier; cell or node identification associated with said uplink and/or downlink signal; time period over which the E-CID timing measurement is done; periodicity of the E-CID timing measurement; Sounding Reference Signal information; and/or measurement gap indication message. In some embodiments the node is the positioning node 17, and the providing circuit 801 is configured to transmit a positioning measurement request message to the user equipment 10 via the radio network node 12. The provided information is comprised in the positioning measurement request message. Furthermore, the node 10, 13, 17, 18 comprises a receiving circuit 802 and a transmitting circuit 803 that may be configured to be used to transmit the information to the radio network node 12.

The embodiments herein for enabling an E-CID timing measurement for positioning of the user equipment 10 in the cell 11 served by the radio network node 12 may be implemented through one or more processors, such as a processing circuit 804 in the node 10, 13, 17, 18 depicted in FIG. 8, together with computer program code for performing the functions and/or method steps of the embodiments herein. The program code mentioned above may also be provided as a computer program product, for instance in the form of a data carrier carrying computer program code for performing embodiments herein when being loaded into the node 10, 13, 17, 18. One such carrier may be in the form of a CD ROM disc. It is however feasible with other data carriers such as a memory stick. The computer program code may furthermore be provided as pure program code on a server and downloaded to the node 10, 13, 17, 18. Those skilled in the art will also appreciate that the various “circuits” described may refer to a combination of analog and digital circuits, and/or one or more processors configured with software and/or firmware, e.g., stored in memory, that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The node 10, 13, 17, 18 may further comprise a memory 805. The memory 805 may comprise one or more memory units and may be used to store for example data such as E-CID timing measurements, configuration information, identities, scheduling data, application/s to perform the methods herein when being executed on the node 10, 13, 17, 18 and/or similar.

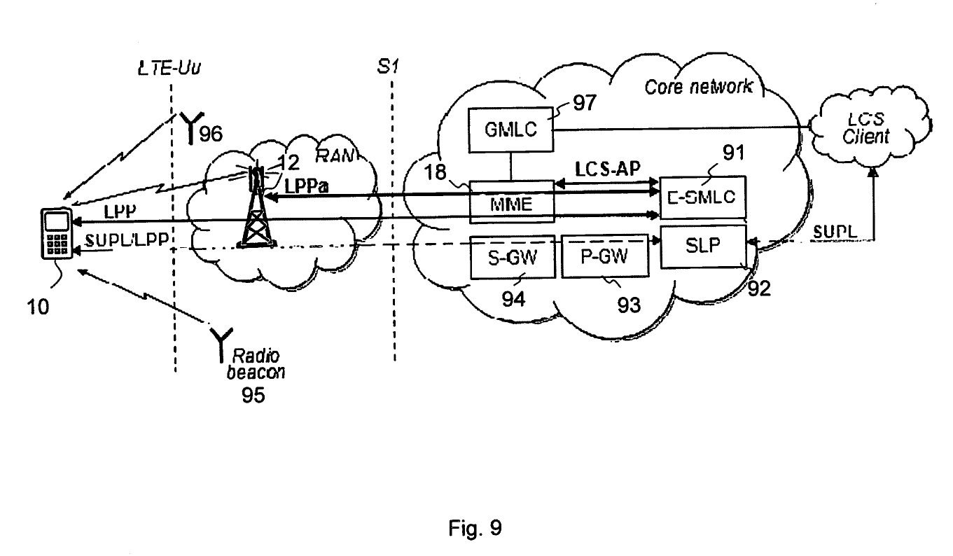

A high-level architecture, as it is currently standardized in LTE, is illustrated in FIG. 9, where an LCS target is the user equipment 10, and an LCS Server is an E-SMLC 91 or an SLP 92. In the figure, the control plane positioning protocols with E-SMLC 91 as the terminating point are shown in dashed arrows, and the user plane positioning protocol is shown in full lined arrows. SLP 92 may comprise two components, SUPL Positioning Centre (SPC) and SUPL Location Centre (SLC), which may also reside in different nodes. In an example implementation, SPC has a proprietary interface with E-SMLC, and LIp interface with SLC, and the SLC part of SLP communicates with a Packet Data Network (PDN)-Gateway (P-GW) 93 and External LCS Client. The P-GW 93 then communicates through a Serving Gateway (S-GW) 94 over the network interface S1 and the air interface LTE-Uu via the radio network node 12.

Additional positioning architecture elements may also be deployed to further enhance performance of specific positioning methods. For example, deploying radio beacons 95,96 is a cost-efficient solution which may significantly improve positioning performance indoors and also outdoors by allowing more accurate positioning, for example, with proximity location techniques.

Also, the signaling described herein is either via direct links, e.g. protocols or physical channels, or logical links e.g. via higher layer protocols and/or via one or more network nodes. For example, in LTE in the case of signaling between E-SMLC and LCS Client the positioning result may be transferred via multiple nodes at least via MME 18 over LCS Application protocol (AP) and/or a Gateway Mobile Location Centre (GMLC) 97.

Although the description is mainly given for the user equipment 10, as measuring unit, it should be understood by the skilled in the art that “UE” is a non-limiting term which means any wireless device or node capable of receiving in DL and transmitting in UL e.g. PDA, laptop, mobile, sensor, fixed relay, mobile relay or even a radio base station, e.g. femto base station. The embodiments may therefore apply for non-CA user equipment or both for user equipments capable and not capable of performing inter-frequency measurements without gaps, e.g. also including user equipments capable of carrier aggregation.

The positioning node 17 described in different embodiments is a node with positioning functionality. For example, for LTE it may be understood as a positioning platform in the user plane, e.g., SLP in LTE, or a positioning node in the control plane, e.g. E-SMLC in LTE. SLP may also comprise SPC and SLC, where SPC may also have a proprietary interface with E-SMLC. In a testing environment, at least positioning node may be simulated or emulated by test equipment.

A cell is associated with a radio node, where a radio node or radio network node or eNodeB used interchangeably in the description, comprises in a general sense any node transmitting radio signals used for measurements, e.g., eNodeB, macro/micro/pico base station (BS), home eNodeB, relay, beacon device, or repeater. A radio node herein may comprise a radio node operating in one or more frequencies or frequency bands. It may be a radio node capable of CA. It may also be a single- or multi-RAT node which may e.g. support Multi-Standard Radio (MSR) or may operate in a mixed mode.

The embodiments are not limited to LTE, but may apply with any RAN, single- or multi-RAT. Some other RAT examples are LTE-Advanced, Universal Mobile Telecommunications System (UMTS), High Speed Packet Access (HSPA), GSM, cdma2000, WiMAX, and Wireless Fidelity (WiFi).

Although many embodiments have been discussed for UE Rx−Tx time difference, they may also be applied to other timing user equipment and radio node, e.g. LMU or eNodeB, measurements, e.g. those that require at least UL transmission. The previous embodiments apply to any user equipment or eNodeB timing measurements which require uplink transmitted signals. The positioning node 17 may for example configure the radio network node 12 to measure it over certain measurement bandwidth and requests the eNodeB/UE to use specific DL and/or UL signals. Example of other timing measurement is one way propagation delay, RTT, TA (e.g., Type 1). The timing measurements may be used internally by the user equipment, in its general sense, and/or reported to another node, e.g. the user equipment 10 or radio network node 12 or network node e.g. positioning node 17.

In yet another embodiment, the procedures described herein e.g., configuring or reconfiguring etc.) may be associated with or triggered by the event such as the events described in relation to the contention-based random access.

In one embodiment, it is proposed to use the contention-based random access procedure for UE Rx−Tx time difference measurements. The user equipment 10 may then send in UL on RACH a random access preamble to radio network node 12 using the preamble group information along with the necessary thresholds read from the broadcasted system information and then the user equipment 10 would receive a Random Access Response from the radio network node 12. Some embodiments may apply specifically for timing measurements on a specific carrier frequency or carrier component, e.g., serving carrier, primary carrier component, configured secondary component carrier, etc. Example: performing contention-based random access procedure for a timing measurement can be used on a serving carrier or primary carrier. In yet another embodiment, to enable using the contention-based random access procedure for performing timing measurement the user equipment 10 may need to read the system information or acquire/receive the required information from another network node e.g. in the measurement request from the positioning node 17, where the required information may e.g. be related to at least one preamble, carrier or cell for which the measurements are to be performed. This receiving or acquiring this necessary information is associated with initiating or requesting the measurement. In the handover or the area change cases, the necessary information may also be sent to the target radio network node, e.g. via X2 e.g. in a handover preparation message. In yet another embodiment, the use of contention-based random access for positioning is associated or triggered with a particular event. Some examples of such events: Initial access from RRC_IDLE; RRC Connection Re-establishment procedure; Handover, e.g. inter-cell, inter-frequency or inter-RAT handover; Switching the carrier in CA system, DL data arrival during RRC_CONNECTED requiring random access procedure, e.g. when UL synchronization status is “non-synchronized”; UL data arrival during RRC_CONNECTED requiring random access procedure, e.g. when UL synchronization status is “non-synchronized” or there are no Physical Uplink Control Channel (PUCCH) resources for Scheduling Requests (SR) available; and moving from one area to another area, e.g. synchronization area or service area or tracking area or any area associated with a group of cell.

In yet another embodiment, the user equipment 10 performing contention-based random access for a general case, e.g. the events as listed below, also performs a timing measurement that utilizes the procedure for the measurement, i.e. the measurement is associated with or triggered by the event. The measurement may be used internally by the user equipment 10, in its general sense, and/or reported to another node. e.g. user equipment, radio network node 12, or network node e.g. the positioning node 17.

It has been described that non-contention based random access procedure may be used for eNodeB Rx−Tx time difference measurements, also referred to as radio network node Receiving and Transmitting time difference measurements. The procedure applies for PCell only. It is therefore that eNodeB Rx−Tx time difference measurements may be performed on an UL signal, e.g., SRS or DRS, configured by eNodeB in the request to assist the eNodeB Rx−Tx time difference measurement, where the request may be a configuration message for the said UL signal. The request and the said UL signal may be transmitted on the same frequency/Component Carrier (CC) or different frequencies/CCs or different bands or different RATs. In one embodiment, the configured UL signal transmissions may be aperiodic and triggered by an event, e.g., by the received request in this specific example. Unlike with the prior art, the described approach allows, e.g., for performing eNodeB Rx−Tx time difference measurements on at least one Secondary Component Carrier (SCC).

In some embodiments the user equipment 10 in FIG. 1 receives via the serving cell 14 a positioning measurement request to enable performing at least one timing measurement for positioning the user equipment 10. The user equipment 10 then transmit a random access preamble on an indicated carrier frequency or component carrier to the radio network node 12 hereby enabling the user equipment 10 to perform the requested measurement. The indicated carrier frequency or component carrier comprise primary carrier or secondary carrier. The user equipment 10 may, after the receiving but prior the transmitting, read system information to acquire information of carrier frequency or component carrier from the radio network node 12 to enable timing measurements. The information may e.g. be related to at least one preamble, carrier or cell for which the timing measurement is to be performed.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1.-36. (canceled)

37. A method in a radio network node for enabling an Enhanced Cell Identity (E-CID) timing measurement for positioning of a user equipment in a cell served by the radio network node, the method comprising:
obtaining information that the user equipment in the cell is requested to perform an E-CID timing measurement by a positioning node;
configuring uplink and/or downlink signals that are needed to perform the E-CID timing measurement.

38. The method of claim 37 wherein the obtaining information comprises receiving the information from any of: the user equipment, the positioning node, another radio network node, a core network node, or a gateway node.

39. The method of claim 37 wherein the obtaining the information comprises obtaining the information from a measurement gap indication message or a measurement gap request message.

40. The method of claim 37 wherein obtaining the information comprises obtaining the information via cross layer communication by reading a positioning measurement request message sent to the user equipment via the radio network node.

41. The method of claim 37 wherein the information obtained comprises an indication of one or more of:
a type of uplink signal and/or downlink signal for performing the E-CID timing measurement;
a bandwidth of the uplink signal and/or downlink signal;
a frequency or component carrier of the uplink and/or downlink signal;
a cell or node identification associated with the uplink and/or downlink signal;
a time period over which the E-CID timing measurement should be done;
a periodicity of the E-CID timing measurement;
Sounding Reference Signal information;
a measurement gap indication message.

42. The method of claim 37 wherein obtaining the information comprises obtaining the information from a positioning measurement request message sent by the positioning node to the user equipment.

43. The method of claim 37 wherein the configuring comprises performing configuration of at least one of:
a downlink signal over a bandwidth in one or more cells operating on one or more frequencies;
a uplink signal over a bandwidth in one or more cells operating on one or more frequencies;
a measurement gap;
a time period over which the downlink and/or uplink signals are transmitted.

44. The method of claim 37 wherein the configuring uplink and/or downlink signals comprises configuring the uplink and/or downlink signals based on obtained configuration information.

45. The method of claim 37 wherein the configuring uplink and/or downlink signals comprises configuring the uplink and/or downlink signals based on pre-defined configuration information.

46. The method of claim 37 further comprising transmitting the configuration of downlink signal and/or the uplink signal to one of the user equipment, the positioning node, and another radio network node.

47. The method of claim 37 wherein the configuring uplink and/or downlink signals comprises configuring the uplink and/or downlink signals over a time period, the time period being predefined or indicated by one of the user equipment, the positioning node, another radio network node, and a core network node.

48. The method of claim 37 wherein the uplink signal is at least one of a Sounding Reference Signal and a Dedicated Reference Signal.

49. The method of claim 37 wherein the downlink signal is at least one of a Cell specific Reference Signal and a Demodulation Reference Signal.

50. The method of claim 37 wherein the information obtained comprises a configuration of at least the downlink or uplink signal.

51. A method in a node for enabling an enhanced cell Identity (E-CID) timing measurement for positioning of a user equipment in a cell served by a radio network node, the method comprising:
sending information to the radio network node, the information indicating that the user equipment in the cell is requested by a positioning node to perform an E-CID timing measurement.

52. The method of claim 51 wherein sending the information comprises sending the information in a measurement gap indication message or a measurement gap request message.

53. The method of claim 51 wherein the information comprises an indication of one or more of:
type of uplink signal and/or downlink signal for performing the E-CID timing measurement;
bandwidth of the uplink signal and/or downlink signal;
frequency or component carrier of the uplink and/or downlink signal;
cell or node identification associated with the uplink and/or downlink signal;
time period over which the E-CID timing measurement is done;
periodicity of the E-CID timing measurement;
Sounding Reference Signal information;
a measurement gap indication message.

54. The method of claim 51:
wherein the node is the positioning node;
wherein the sending the information comprises sending the information to the user equipment via the radio network node in a positioning measurement request message.

55. A radio network node for enabling an enhanced cell Identity (E-CID) timing measurement for positioning of a user equipment in a cell, the radio network node configured to serve the cell, the radio network node comprising:
an obtaining circuit configured to obtain information that the user equipment in the cell is requested by a positioning node to perform an E-CID timing measurement;
a configuring circuit adapted to configure uplink and/or downlink signals that are needed to perform the E-CID timing measurement.

56. The radio network of claim 55 wherein the obtaining circuit is configured to obtain the information from one of:
the user equipment;
the positioning node;
another radio network node;
a core network node;
a gateway node.

57. The radio network node of claim 55 wherein the information is in a measurement gap indication message or measurement gap request message.

58. The radio network node of claim 55 wherein the obtaining circuit is configured to obtain the information via cross layer communication by reading a positioning measurement request message sent to the user equipment via the radio network node.

59. The radio network node of claim 55 wherein the information comprises one or more of:
a type of the uplink signal and/or downlink signal for performing the E-CID timing measurement;
a bandwidth of the uplink signal and/or downlink signal;
a frequency or component carrier of the uplink signal and/or downlink signal;
a cell or node identification associated with the uplink and/or downlink signal;
a time period over which the E-CID timing measurement should be done;
a periodicity of the E-CID timing measurement;
a measurement gap indication message.

60. The radio network node of claim 55 wherein the information is in a positioning measurement request message sent by the positioning node to the user equipment.

61. The radio network node of claim 55 wherein the configuring circuit is adapted to perform configuration of at least one of:
the downlink signal over a bandwidth in one or more cells operating on one or more frequencies;
the uplink signal over a bandwidth in one or more cells operating on one or more frequencies;
measurement gap;
a time period over which the downlink signal and/or uplink signal are transmitted.

62. The radio network node of claim 55 wherein the configuring circuit is adapted to perform configuration based on obtained configuration information.

63. The radio network node of claim 55 wherein the configuring circuit is adapted to perform configuration based on pre-defined configuration information.

64. The radio network node of claim 55 further comprising a transmitting circuit configured to transmit the configuration of downlink signal and/or the uplink signal to one of: the user equipment, the positioning node, another radio network node.

65. The radio network node of claim 55 wherein the configuring circuit is adapted to perform the configuration over a time period, the time period being predefined or indicated from one of: the user equipment, the positioning node, another radio network node, a core network node.

66. The radio network node of claim 55 wherein the uplink signal is at least one of a Sounding Reference Signal and a Dedicated Reference Signal

67. The radio network of claim 55 wherein the downlink signal is at least one of a Cell specific Reference Signal and a Demodulation Reference Signal.

68. The radio network node of claim 55 wherein the E-CID timing measurement is any of:
User Equipment Receiving-Transmitting time difference;
radio network node Receiving-Transmitting time difference;
timing advance between the user equipment and the radio network node;
propagation delay between the user equipment and the radio network node.

69. The radio network node of claim 55 wherein the radio network node is one of: an eNode B, a relay node, a base station, a Multi-Standard Radio (MSR) node, a beacon device, an access point, a repeater.

70. The radio network node of claim 55 wherein the information comprises a configuration of at least the downlink or uplink signal.

71. A node for enabling an enhanced cell Identity (E-CID) timing measurement for positioning of a user equipment in a cell served by a radio network node, the node comprising:
a providing circuit configured to send information to the radio network node, the information indicating that the user equipment in the cell is requested by a positioning node to perform an E-CID timing measurement.

72. The node according to claim 71 wherein the providing circuit is configured to send the information to the radio network node in a measurement gap indication message or a measurement gap request message.

73. The node according to claim 71 wherein the information comprises an indication of one or more of:
type of uplink signal and/or downlink signal for performing the E-CID timing measurement;
bandwidth of the uplink signal and/or downlink signal;
frequency or component carrier of the uplink and/or downlink signal;
cell or node identification associated with the uplink and/or downlink signal;
time period over which the E-CID timing measurement is done;
periodicity of the E-CID timing measurement;
Sounding Reference Signal information;
a measurement gap indication message.

74. The node according to claim 71:
wherein the node is a positioning node;
wherein the providing circuit is configured to transmit a positioning measurement request message to the user equipment via the radio network node, the information present in the positioning measurement request message.
